(19) United States
(12) Patent Application Publication
(10) Pub. No.: US 2026/0247393 A1
(43) Pub. Date: Aug. 20, 2026

(54) TRANSMITTING METHOD AND APPARATUS FOR PDCCH

(71) Applicant: Beijing Xiaomi Mobile Software Co., Ltd., Beijing (CN)

(72) Inventors: Xuemei QIAO, Beijing (CN); Qin MU, Beijing (CN); Qun ZHAO, Beijing (CN)

(21) Appl. No.: 18/852,410

(22) PCT Filed: Apr. 8, 2022
(86) PCT No.: PCT/CN2022/085974

§ 371 Date: Sep. 27, 2024

(51) Int. Cl. H04W 72/23; H04W 72/044

(52) U.S. Cl. CPC H04W 72/23; H04W 72/044

(57) ABSTRACT

Embodiments of the present application disclose a PDCCH transmission method and an apparatus thereof, which can be applied to a communication system. The method comprises: acquiring a CORESET configured by a network device, wherein the CORESET comprises a REG, and a first symbol length occupied by the CORESET is greater than 3 (S21); determining a REG number of the REG, and mapping, according to the REG number and the granularity of REG bundles, the REG configured for the CORESET to one or more REG bundles (S22); and performing resource mapping on the REG bundles to obtain CCEs, so as to receive a PDCCH sent by the network device (S23). In the embodiments of the present application, by increasing the symbol length of the CORESET, expanding the capacity of the CORESET, and mapping the REG bundles to the CCEs, a higher CCE aggregation degree is obtained, and the transmission reliability of the PDCCH channel is thus improved.

### CROSS-REFERENCE TO RELATED APPLICATIONS

The present application is a U.S. National Stage of International Application No. PCT/CN2022/085974, entitled “PDCCH TRANSMISSION METHOD AND APPARATUS THEREOF”, filed on Apr. 8, 2022, the contents of all of which are incorporated herein by reference in their entireties for all purposes.

### BACKGROUND

By reducing a bandwidth of a reduced capability (Redcap) terminal, types of services supported by the Redcap terminal can be increased. For example, when a radio frequency (RF) and a baseband bandwidth of the Redcap terminal are reduced to 5 MHZ at a low frequency 1 (FR1), the type of services such as factory sensors low in data rate and sensitive in cost can be supported.

### SUMMARY

The disclosure relates to the technical field of communication, and in particular to a transmitting method and apparatus for PDCCH.

In a first aspect, the examples of the disclosure provide a transmitting method for PDCCH. The method includes:
obtaining a control resource set (CORESET) configured by a network device, where the CORESET includes a resource element group (REG), and a first symbol length occupied by the CORESET is greater than 3;
determining a REG number of the REG, and mapping the REG into one or more REG bundles according to the REG number and granularity of the REG bundles; and
obtaining a control channel element (CCE) by performing resource mapping on one or more the REG bundles, so as to receive a PDCCH transmitted from the network device.

In a second aspect, the examples of the disclosure provide another transmitting method for PDCCH. The method includes:
determining, according to a first symbol length occupied by a CORESET currently, the CORESET configured for a terminal, where the CORESET includes a REG, and the first symbol length is greater than 3;
determining a REG number of the REG, and mapping the REG into one or more REG bundles according to the REG number and granularity of the REG bundles;
obtaining a CCE by performing resource mapping on the one or more REG bundles; and
transmitting the PDCCH to the terminal.

In a third aspect, the examples of the disclosure provide a communication apparatus. The communication apparatus has some or all of functions of the terminal in the method of the first aspect. For example, the communication apparatus may have some or all of the functions in the examples of the disclosure, or may have the functions of implementing any one of the examples of the disclosure alone. The functions may be implemented through hardware, or by executing corresponding software by hardware. The hardware or software includes one or more units or modules corresponding to the above functions.

In an implementation, a structure of the communication apparatus may include a transceiving module and a processing module. The processing module is configured to support the communication apparatus to execute corresponding functions in the above method. The transceiving module is configured to support communication between the communication apparatus and other devices. The communication apparatus may further include a storage module. The storage module is configured to be coupled with the transceiving module and the processing module and store computer programs and data necessary for the communication apparatus.

As an instance, the processing module may be a processor, the transceiving module may be a transceiver or a communication interface, and the storage module may be a memory.

In a fourth aspect, the examples of the disclosure provide another communication apparatus. The communication apparatus has some or all of functions of the network device in the method example of the second aspect. For example, the communication apparatus may have some or all of the functions in the examples of the disclosure, or may have the functions of implementing any one of the examples of the disclosure alone. The functions may be implemented through hardware, or by executing corresponding software by hardware. The hardware or software includes one or more units or modules corresponding to the above functions.

In an implementation, a structure of the communication apparatus may include a transceiving module and a processing module. The processing module is configured to support the communication apparatus to execute corresponding functions in the above method. The transceiving module is configured to support communication between the communication apparatus and other devices. The communication apparatus may further include a storage module. The storage module is configured to be coupled with the transceiving module and the processing module and store computer programs and data necessary for the communication apparatus.

In a fifth aspect, the examples of the disclosure provide a communication apparatus. The communication apparatus includes a processor. The processor executes the method of the first aspect when calling a computer program stored in a memory.

In a sixth aspect, the examples of the disclosure provide a communication apparatus. The communication apparatus includes a processor. The processor executes the method of the second aspect when calling a computer program stored in a memory.

In a seventh aspect, the examples of the disclosure provide a communication apparatus. The communication apparatus includes a processor and a memory. The memory stores a computer program. The processor executes the computer program stored in the memory to cause the communication apparatus to execute the method of the first aspect.

In an eighth aspect, the examples of the disclosure provide a communication apparatus. The communication apparatus includes a processor and a memory. The memory stores a computer program. The processor executes the computer program stored in the memory to cause the communication apparatus to execute the method of the second aspect.

In a ninth aspect, the examples of the disclosure provide a communication apparatus. The communication apparatus includes a processor and an interface circuit. The interface circuit is configured to receive a code instruction and transmit the code instruction to the processor. The processor is configured to run the code instruction to cause the communication apparatus to execute the method of the first aspect.

In a tenth aspect, the examples of the disclosure provide a communication apparatus. The communication apparatus includes a processor and an interface circuit. The interface circuit is configured to receive a code instruction and transmit the code instruction to the processor. The processor is configured to run the code instruction to cause the communication apparatus to execute the method of the second aspect.

In an eleventh aspect, the examples of the disclosure provide a non-transitory computer-readable storage medium. The non-transitory computer-readable storage medium is configured to store an instruction for the terminal described above. When the instruction is executed, the terminal is caused to execute the method of the first aspect.

In a twelfth aspect, the examples of the disclosure provide a non-transitory computer-readable storage medium. The non-transitory computer-readable storage medium is configured to store an instruction for the network device described above. When the instruction is executed, the network device is caused to execute the method of the second aspect.

### BRIEF DESCRIPTION OF DRAWINGS

In order to more clearly illustrate the examples of the disclosure or the technical solution in the background, the accompanying drawings to be used in the examples of the disclosure or the background will be explained below.

FIG. 1 is a schematic diagram of an architecture of a communication system according to an example of the disclosure;

FIG. 2 is a schematic flowchart of a transmitting method for PDCCH according to an example of the disclosure;

FIG. 3 is a schematic flowchart of a transmitting method for PDCCH according to an example of the disclosure;

FIG. 4 is a schematic numbering diagram of a numbering rule according to an example of the disclosure;

FIG. 5 is a schematic numbering diagram of another numbering rule according to an example of the disclosure;

FIG. 6 is a schematic numbering diagram of another numbering rule according to an example of the disclosure;

FIG. 7 is a schematic numbering diagram of another numbering rule according to an example of the disclosure;

FIG. 8 is a schematic flowchart of a transmitting method for PDCCH according to an example of the disclosure;

FIG. 9 is a schematic flowchart of a transmitting method for PDCCH according to an example of the disclosure;

FIG. 10 is a schematic flowchart of a transmitting method for PDCCH according to an example of the disclosure;

FIG. 11 is a schematic flowchart of a transmitting method for PDCCH according to an example of the disclosure;

FIG. 12 is a schematic flowchart of a transmitting method for PDCCH according to an example of the disclosure;

FIG. 13 is a schematic flowchart of a transmitting method for PDCCH according to an example of the disclosure;

FIG. 14 is a schematic structural diagram of a communication apparatus according to an example of the disclosure;

FIG. 15 is a schematic structural diagram of a communication apparatus according to an example of the disclosure; and

FIG. 16 is a schematic structural diagram of a chip according to an example of the disclosure.

### DETAILED DESCRIPTION

By reducing a bandwidth of the Redcap terminal, types of services supported by the Redcap terminal can be increased. For example, when a radio frequency (RF) and a baseband bandwidth of the Redcap terminal are reduced to 5 MHZ at a low frequency 1 (FR1), the type of services such as factory sensors low in data rate and sensitive in cost can be supported. However, reducing the bandwidth to 5 MHZ results in a smaller number of control channel elements (CCEs), an influence on transmission reliability of a physical downlink control channel (PDCCH), and incapability to support a higher aggregation level (AL).

Examples of the disclosure provide a transmitting method and apparatus for PDCCH. A capacity of a CORESET is expanded by increasing a symbol length of the CORESET, and a higher aggregation degree of the CCE is obtained, such that transmission reliability of the PDCCH is improved.

Description will be made in detail to illustrative examples here, and their instances are illustrated in the accompanying drawings. When the following description relates to the accompanying drawings, the same numbers in different accompanying drawings denote the same or similar elements, unless indicated otherwise. The examples described in the following illustrative examples do not represent all examples consistent with the disclosure. Rather, they are instances of apparatuses and methods consistent with some aspects of the disclosure as detailed in the appended claims.

The terms used in the examples of the disclosure are used to describe specific examples, rather than limit the examples of the disclosure. The singular forms such as “a/an” and “the” used in the examples of the disclosure and the appended claims are also intended to include the plural forms, unless clearly stated in the context otherwise. It may also be understood that the term “and/or” used here means and encompasses one or any or all possible combinations of a plurality of associated items listed.

It may be understood that while the terms first, second, third, etc. may be employed in the examples of the disclosure to describe various information, these information may not be limited to this. These terms are used to distinguish between the same type of information. For example, first information can also be referred to as second information, and similarly, the second information can also be referred to as the first information, without departing from the scope of the examples of the disclosure. Depending on the context, the word “if” as used here can be interpreted as “at the time of”, “when”, or “in response to determining”.

For concision and easy understanding, the terms “greater than” or “smaller than”, and “higher than” or “lower than” are used here to denote a magnitude relation. However, those skilled in the art can understand that the term “greater than” also covers the meaning of “greater than or equal to”, and the term “smaller than” also covers the meaning of “smaller than or equal to”; and the term “higher than” covers the meaning of “higher than or equal to”, and the term “lower than” also covers the meaning of “lower than or equal to”.

For ease of understanding, terms involved in the disclosure are introduced at first.

Physical downlink control channel (PDCCH): the PDCCH bears scheduling and other control information, specifically including transmission format, resource allocation, uplink scheduling grant, power control, uplink retransmission information, etc.

Control resource set (CORESET): in order to transmit a PDCCH, a network device configures a CORESET for the terminal. The CORESET occupies N OFDM symbols in a time domain and M resource blocks (RBs) in a frequency domain. N may be a positive integer greater than 3, and M may be a positive integer greater than 1.

Resource element group (REG): the REG is a minimum unit for mapping a control channel to a physical resource, and each REG consists of one symbol in the time domain and one RB in the frequency domain.

REG bundle: the REG bundle consists of one or more REGs with consecutive numbers.

Control channel element (CCE): one PDCCH may be transmitted on one or more CCEs with consecutive numbers, each CCE consists of a plurality of resource element groups (REGs), and there is a mapping relation between the CCE and the REG bundle.

In order to better understand a transmitting method for PDCCH disclosed in the examples of the disclosure, a communication system to which the example of the disclosure is applicable is first described below.

With reference to FIG. 1, FIG. 1 is a schematic diagram of an architecture of a communication system according to an example of the disclosure. The communication system may include, but is not limited to, one network device and one terminal. The number and form of devices shown in FIG. 1 are illustrative and do not constitute a limitation to the example of the disclosure. The communication system may include two or more network devices and two or more terminals in an actual application. For example, the communication system shown in FIG. 1 includes one network device 11 and one terminal 12.

It may be noted that the technical solution of the example of the disclosure can be applied to various communication systems, for example, a long term evolution (LTE) system, a 5th generation (5G) mobile communication system, a 5G new radio (NR) system, or other future new mobile communication systems, etc. It may also be noted that a sidelink in the examples of the disclosure may also be referred to as a sidewalk link or a straight-through link.

The network device 101 in the example of the disclosure is an entity on a network side for transmitting or receiving signals. For example, the network device 101 may be an evolved NodeB (eNB), a transmission reception point (TRP), a next generation NodeB (gNB) in an NR system, a base station in other future mobile communication systems, or an access nodes in a wireless fidelity (WiFi) system, etc. The example of the disclosure does not limit a particular technology and a particular device form used by the network devices. The network device provided in the example of the disclosure may be composed of a central unit (CU) and a distributed unit (DU). The CU may also be referred to as a control unit. By using a CU-DU structure, protocol layers of the network device, such as a base station, may be split, functions of some protocol layers are centrally controlled by the CU, and functions of some or all of the remaining protocol layers are distributed in the DU, and the DU is centrally controlled by the CU.

The terminal 102 in the example of the disclosure is an entity on a user side configured to receive or transmit signals, such as a mobile phone. The terminal may also be referred to as a terminal, user equipment (UE), a mobile station (MS), a mobile device (MT), etc. The terminal may be a car with a communication function, a smart car, a mobile phone, a wearable device, a Pad, a computer with a radio transceiving function, a virtual reality (VR) terminal, an augmented reality (AR) terminal, a radio terminal in industrial control, a radio terminal in self-driving, a radio terminal in remote medical surgery, a radio terminal in a smart grid, a radio terminal in transportation safety, a radio terminal in a smart city, a radio terminal in smart home, etc. The example of the disclosure does not limit a particular technology and a particular device form used by the terminal.

In sidelink communication, there are four sidelink transmission modes. Sidelink transmission mode 1 and sidelink transmission mode 2 are used for device-to-device (D2D) communication. Sidelink transmission mode 3 and sidelink transmission mode 4 are used for V2X communication. When the sidelink transmission mode 3 is used, resource allocation is scheduled by the network device 101. Specifically, the network device 101 may transmit resource allocation information to the terminal 102, and the terminal 102 allocates resources to another terminal, such that the another terminal may transmit information to the network device 101 through the allocated resources. In V2X communication, a terminal with a better signal or higher reliability may be used as the terminal 102. A first terminal mentioned in the examples of the disclosure may refer to the terminal 102, and a second terminal may refer to the another terminal.

It can be understood that the communication system described in the examples of the disclosure is for the purpose of more clearly illustrating the technical solutions provided in the examples of the disclosure, and does not constitute a limitation on the technical solutions provided in the examples of the disclosure. Those skilled in the art will know that the technical solutions provided in the examples of the disclosure are also applicable to similar technical problems along with evolution of a system architecture and emergence of new service scenes.

The transmitting method and an apparatus for PDCCH provided in the disclosure are described in detail below in conjunction with the accompanying drawings.

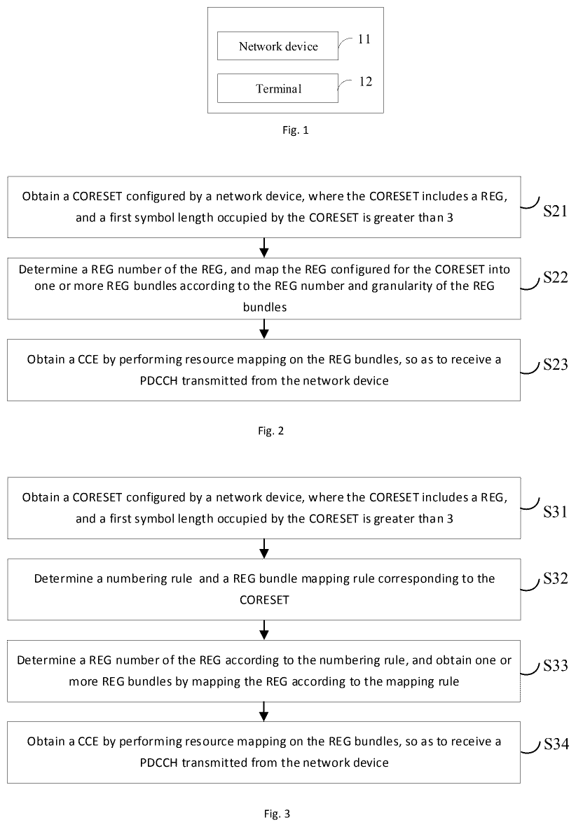

With reference to FIG. 2, FIG. 2 is a schematic flowchart of a transmitting method for PDCCH according to an example of the disclosure. The method is executed by a terminal. As shown in FIG. 2, the method may include, but is not limited to:

S21, a CORESET configured by a network device is obtained, where the CORESET includes a REG, and a first symbol length occupied by the CORESET is greater than 3.

In order to support a reduced capability (Redcap) terminal in transmitting a PDCCH by using as many resources as possible to enhance coverage, in the example of the disclosure, the symbol length of the control resource set (CORESET) may be increased to increase the number of resource element groups (REGs) configured in the CORESET, such that a higher aggregation level (AL) can be supported.

For example, when sub-carrier spacing (SCS) is 15 KHz, duration of the CORESET, that is, a value range of the occupied first symbol length, may be {1, 2, 3, 4, 6}. In some implementations, the first symbol length may also be longer to reduce blocking probability of the PDCCH, such as supporting {1, 2, 3, 4, 6, 8, 10}, etc.

For example, when the SCS is 30 kHz, the symbol length of the CORESET may be more, such as increasing to 12 symbols or extending to an entire slot. For example, when the symbol length of the CORESET is extended to the entire slot, the CORESET may include 84 REGs (14*6).

In some examples, frequency domain resource allocation is performed in a manner similar to PDSCH resource allocation type 0 in a frequency domain. In some examples, continuous resource allocation or discrete resource allocation may be implemented. For example, granularity of frequency domain resource allocation may be 6 RBs, 12 RBs or 24 RBs.

In the example of the disclosure, the terminal may obtain the CORESET configured by the network device. The configured CORESET includes a REG. The first symbol length occupied by the CORESET is greater than 3, that is, the number of symbols occupied by the CORESET and the number of REGs are increased.

In some examples, the terminal may receive the CORESET configured by the network device through higher layer signaling. For example, the terminal may obtain the CORESET configured by the network device through radio resource control (RRC) signaling, media access control-control element (MAC-CE) signaling, system information block 1 (SIB1) or other higher layer signaling.

In some examples, based on the increase in the first symbol length of the Redcap terminal, time and frequency domain resource value sets of the CORESET may be jointly designed. For example, a protocol specifies several value sets of {number of symbols, number of RBs}. The terminal may receive indication information from the network device. The indication information carries one index of the value sets of {number of symbols, number of RBs} specified in the protocol.

In some examples, a mapping relation between the number of symbols, the number of RBs, and the index is configured in advance, as shown in Table 1 below:

TABLE 1

| | Number of | Number |
|---|---|---|
| Index | symbols | of RBs |
| 0-2 | 1 | 6, 12, 24 |
| 3-5 | 2 | 6, 12, 24 |
| 6-8 | 3 | 6, 12, 24 |
| 9-11 | 4 | 6, 12, 24 |
| 12-14 | 6 | 6, 12, 24 |
| 15 | 12 | 6 |

It may be understood that each element in Table 1 is independent, and these elements are illustratively listed in the same table, but it does not mean that all the elements in the table must be present at the same time as shown in the table. A value of each element is independent of a value of any other element in Table 1. Thus, those skilled in the art may understand that the value of each element in Table 1 is an independent example.

Further, the terminal may receive an index of the network device, and determine the first symbol length corresponding to the CORESET and the number of occupied RBs from the mapping table of time-frequency domain resources according to the index.

In some examples, the terminal may implicitly determine the symbol length/the number of symbols of a corresponding time domain according to information such as a number of frequency domain resources configured by the network device and a configured highest aggregation level.

In some implementations, the mapping relation of the number of RBs-aggregation level-symbol length/the number of symbols is preset. After the number of RBs configured by the network device and the highest aggregation level are obtained, the terminal queries the mapping relation to determine the symbol length/the number of symbols occupied by the CORESET. For example, when the number of RBs is 6, and the highest aggregation level is 8, it can be determined that the symbol length/the number of symbols occupied by the CORESET is 8. When the number of RBs is 12, and the highest aggregation level is 16, the symbol length is 8.

In some examples, the number of frequency domain resources corresponding to each time unit included in the CORESET may be the same or not.

S22, a REG number of the REG is determined, and the REG configured for the CORESET is mapped into one or more REG bundles according to the REG number and granularity of the REG bundles.

After the CORESET is obtained, the REGs in the CORESET may be numbered. In implementations, one or more candidate numbering rules may be included. A REG numbering rule corresponding to the CORESET may be determined from the plurality of candidate numbering rules through a protocol agreement or a network indication. Further, the terminal obtains the REG number of each REG by numbering the REGs in the CORESET according to the numbering rule.

In some examples, the numbering rule of the REGs may be determined from two dimensions of a frequency domain and a time domain. For example, the numbering rule may be determined in a manner that time domain resources are numbered followed by frequency domain resources or a manner that frequency domain resources are numbered followed by time domain resources. Alternatively, the REGs in the CORESET may be grouped, and different numbering rules may be used for different groups.

After the one or more REG numbers are obtained, the REGs in the CORESET may be mapped to obtain one or more REG bundles, that is, the REGs in the CORESET are divided into one or more REG bundles. One REG bundle includes several REGs consecutive in a time domain and/or a frequency domain.

In some examples, the one or more REG bundles are obtained by mapping to the REG bundles according to a sequence of the REG number based on original first granularity of the REG bundles. For example, the original first granularity of the REG bundles may be {2, 3, 6}. That is to say, the terminal numbers the REGs according to the existing supportable second symbol length/the number of second symbols of the CORESET in a manner that time domain resources are numbered followed by frequency domain resources, that is, continues to number REGs on a newly added symbol based on the current REG numbers. After numbering is completed, the REG packets are mapped according to a sequence of the REG numbers to obtain the REG bundles.

It may be noted that without changing original basic granularity, that is, the first granularity, of the REG bundles, the first granularity of the REG bundles and the newly added first symbol length (except 1, 2, and 3) may satisfy the following relation: a modulus obtained by the configured first symbol length mod the first granularity is equal to 0. That is to say, possible values of the newly added first symbol length may include one or more of {6, 8, 9, 10, 12, 14}.

In the disclosure, after the first symbol length of the CORESET is increased, and updated second granularity of the REG bundles may be obtained by increasing the granularity of the REG bundles. In some examples, the one or more REG bundles may be obtained by mapping a REG packet according to a sequence of the REG number based on the updated second granularity of the REG bundles. For example, the second granularity of the REG bundles may be {4, 8, etc.}. It may be noted that after part of the second granularity is added, the granularity of the REG bundles may be {2, 3, 4, 6, 8, etc.}.

In implementations, a plurality of candidate mapping rules may be included. The mapping rule corresponding to the REG may be determined from the plurality of candidate mapping rules through a protocol agreement or a network indication. Based on the mapping rule, the terminal performs mapping according to the sequence of the REG numbers, so as to obtain one or more REG bundles. For example, 6 consecutive REGs may be divided into one REG bundle, and another example, 8 consecutive REGs may be divided into one REG bundle. In some examples, after the one or more REG bundles are obtained, the REG bundles may also be numbered and identified.

In some examples, there may be a corresponding relation between the numbering rules and the mapping rules. After one rule is determined, the other rule may be determined.

S23, a CCE is obtained by performing resource mapping on the one or more REG bundles, so as to receive a PDCCH transmitted from the network device.

In some examples, after the one or more REG bundle is obtained, the REG bundle may be mapped to the CCE in an interleaving or non-interleaving manner for the REG bundle.

There are a plurality of candidate PDCCHs in implementations, and each candidate PDCCH may correspond to one or more different CCEs. The terminal may receive configurations of the CORESET and a search space transmitted from the network device, determine positions of the plurality of candidate PDCCHs according to the two configurations, and attempt to perform PDCCH blind detection on a plurality of candidate PDCCH channels. The candidate PDCCH channel that succeeds at last during the blind detection is the channel for transmitting the PDCCH.

In the example of the disclosure, the CORESET configured by the network device is obtained, where the CORESET includes the REG, and the first symbol length occupied by the CORESET is greater than 3; the REG number of the REG is determined, and the REG is mapped into one or more REG bundles according to the REG number and the granularity of the REG bundles; and the CCE is obtained by performing resource mapping on the one or more REG bundles, so as to receive the PDCCH transmitted from the network device. In the example of the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved.

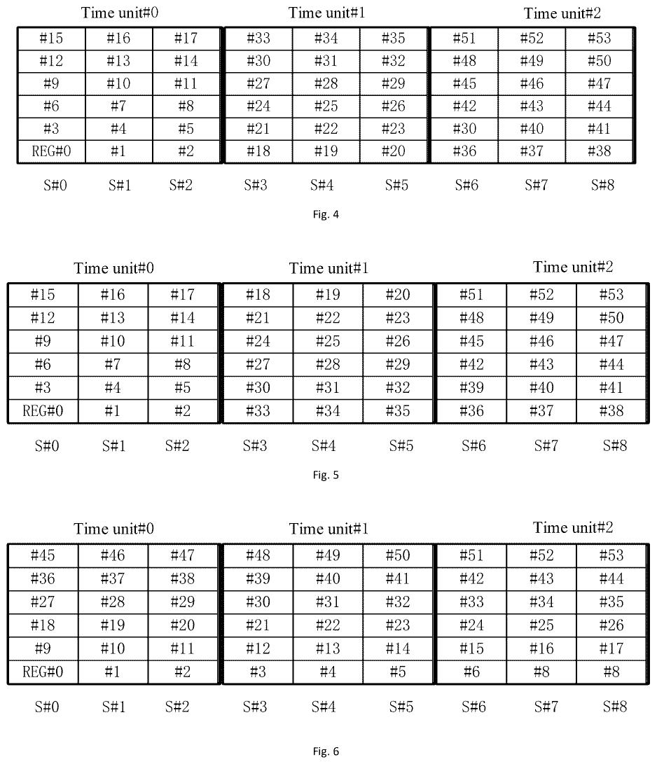

With reference to FIG. 3, FIG. 3 is a schematic flowchart of a transmitting method for PDCCH according to an example of the disclosure. The method is executed by a terminal. As shown in FIG. 3, the method may include, but is not limited to:

S31, a CORESET configured by a network device is obtained, where the CORESET includes a REG, and a first symbol length occupied by the CORESET is greater than 3.

Any implementation in various examples of the disclosure may be used as an implementation of S31, and details are omitted here.

S32, a numbering rule and a REG bundle mapping rule corresponding to the CORESET are determined.

S33, a REG number of the REG is determined according to the numbering rule, the REG is mapped according to the mapping rule, and one or more REG bundles are obtained.

After the CORESET is obtained, the REGs in the CORESET may be numbered. In implementations, a plurality of candidate numbering rules may be included. A numbering rule corresponding to the CORESET may be determined through a protocol agreement or a network indication. Further, the terminal obtains the REG number of each REG by numbering the REGs in the CORESET according to the determined numbering rule.

In implementations, a plurality of candidate mapping rules may be included. The mapping rule corresponding to the REG may be determined through a protocol agreement or a network indication. Based on the determined mapping rule, mapping is performed according to the sequence of the REG numbers, so as to obtain one or more REG bundles. For example, 6 consecutive REGs may be divided into one REG bundle, and another example, 8 consecutive REGs may be divided into one REG bundle.

Each candidate numbering rule is explained separately below:

In some examples, candidate numbering rule 1: the CORESET includes K time units, the K time units are sorted in a time sequence first, and the REGs within each time unit are numbered in a manner that time domain resources are numbered followed by frequency domain resources, where K is a positive integer greater than or equal to 2, and the time unit includes one or more symbols.

For example, as shown in FIG. 4, the first symbol length of the CORESET is 9 symbols, symbols #0-#2 are one time unit 0, symbols #3-#5 are one time unit 1, and symbols #6-#8 are one time unit 2, that is, three time units are included. In the instance, the REGs in the CORESET are subjected to REG numbering according to the candidate numbering rule 1. Specifically, REGs in the time unit 0 are numbered in a manner that time domain resources are numbered followed by frequency domain resources to obtain REG #0-#17; REGs in the time unit 1 are numbered in a manner that time domain resources are numbered followed by frequency domain resources to obtain REG #18-#35; and REGs in the time unit 2 are numbered in a manner that time domain resources are numbered followed by frequency domain resources to obtain REG #36-#53.

Alternatively, candidate numbering rule 2: the CORESET includes K time units, and the K time units are sorted in a time sequence, where K is a positive integer greater than or equal to 2. REGs within odd-numbered time units among the K time units are numbered in a manner that time domain resources are numbered followed by frequency domain resources and the frequency domain resources are numbered in reverse order. REGs within even-numbered time units among the K time units are numbered in a manner that time domain resources are numbered followed by frequency domain resources and the frequency domain resources are numbered in sequential order.

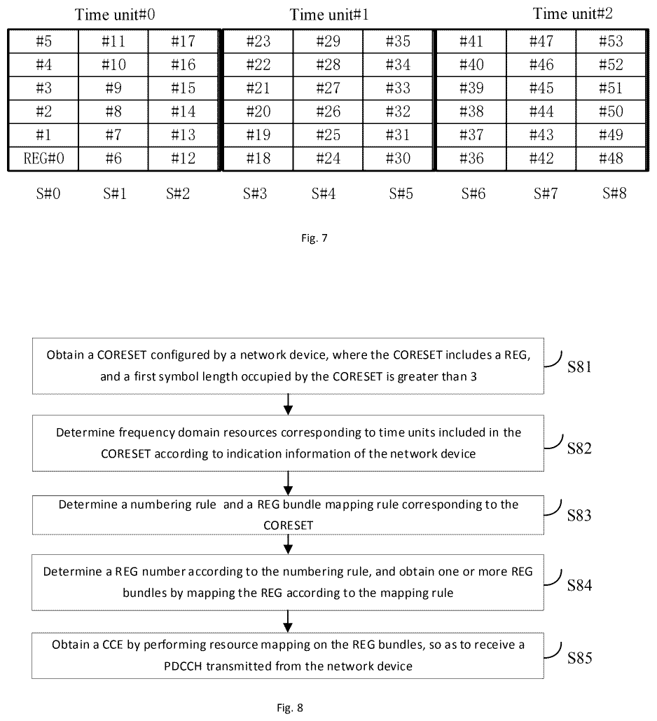

For example, as shown in FIG. 5, the first symbol length of the CORESET is 9 symbols, symbols #0-#2 are one time unit 0, symbols #3-#5 are one time unit 1, and symbols #6-#8 are one time unit 2, that is, three time units are included. In the instance, the REGs in the CORESET are subjected to REG numbering according to candidate numbering rule 2. Specifically, REGs in the time unit 0 are numbered in a manner that time domain resources are numbered followed by frequency domain resources and the frequency domain resources are numbered in sequential order, to obtain REG #0-#17; REGs in the time unit 1 are numbered in a manner that time domain resources are numbered followed by frequency domain resources and the frequency domain resources are numbered in reverse order, to obtain REG #18-#35; and REGs in the time unit 2 are numbered in a manner that time domain resources are numbered followed by frequency domain resources and the frequency domain resources are numbered in sequential order, to obtain REG #36-#53.

It may be noted that the REGs #18-#35 numbered according to the candidate numbering rule 1 have the same number as the REGs #18-#35 numbered according to the candidate numbering rule 2, but the REGs corresponding to the same number may have different corresponding frequency domain positions. For example, the REG #18 numbered according to the candidate numbering rule 1 occupies RB #0 in a frequency domain, and the REG #18 numbered according to candidate numbering rule 2 occupies RB #5 in a frequency domain.

It may be noted that the CORESET includes a time domain length of the time unit, that is, the number of symbols included in the time unit can be determined according to the newly added first symbol length and the original second symbol length of the CORESET.

In some examples, an original symbol length set of the CORESET is determined, where the original symbol length set includes at least one original second symbol length. It is determined that the first symbol length is divisible by one and only one second symbol length in the symbol length set, and the one and only one second symbol length is determined as the time domain length of the time unit; it is determined that the first symbol length is divisible by all the second symbol lengths in the symbol length set, one of the second symbol lengths is determined as the time domain length of the time unit; and it is determined that the first symbol length is indivisible by any one of the second symbol lengths, 1 is determined as the time domain length of the time unit, and alternatively, the first symbol length is adjusted until the first symbol length is divisible by one of the second symbol lengths.

Illustratively, the CORESET has an original symbol length set {1, 2, 3}. In a case that the first symbol length corresponding to the CORESET is divisible by one and only one of the original symbol length set {2, 3}, a divisor can be taken as the time domain length of the time unit. For example, in a case that the first symbol length is divisible by 2, 2 is taken as the time domain length of the time unit. For example, in a case that the first symbol length is divisible by 3, 3 is taken as the time domain length of the time unit.

In a case that the first symbol length corresponding to the CORESET is divisible by any one of {2, 3}, 2 or 3 may be taken as the time domain length of the time unit. For example, one of 2 and 3 may be indicated as the time domain length of the time unit by a protocol agreement or a display indication of the network device.

In a case that the first symbol length corresponding to the CORESET is indivisible by any one of {2, 3}, the time domain length of the time unit can only be 1. Alternatively, the first symbol length corresponding to the CORESET may be configured to be divisible by any one of {2, 3}.

It may be noted that a common CORESET and a UE specific CORESET are applicable. In the disclosure, some common CORESET resources of legacy UE and a Redcap terminal may overlap, and the network device only needs to issue some number bits on frequency domain resources exceeding a Redcap bandwidth on extra symbol resources, so as to be beneficial to reduction in system overhead.

In some examples, candidate numbering rule 3: REGs on all symbols occupied by the CORESET are numbered in a manner that time domain resources are numbered followed by frequency domain resources.

Illustratively, as shown in FIG. 6, the first symbol length of the CORESET is 9 symbols. The REGs on all the symbols, that is, symbols #0-#8, may be numbered in a manner that time domain resources are numbered followed by frequency domain resources, that is, symbol #0 to symbol #8 are sequentially numbered according to an order from low to high in a frequency domain. Assuming that 6 RBs are included, RB #0 is numbered from symbol #0 to symbol #8 to obtain REG #0-REG #8; RB #1 is numbered from symbol #0 to symbol #8 to obtain REG #9-REG #17; RB #2 is numbered from symbol #0 to symbol #8 to obtain REG #18-REG #26, and so on until RB #5 is numbered from symbol #0 to symbol #8 to obtain REG #45-REG #53.

In some examples, candidate numbering rule 4: REGs on all symbols occupied by the CORESET are numbered in a manner that frequency domain resources are numbered followed by time domain resources.

Illustratively, as shown in FIG. 7, the first symbol length of the CORESET is 9 symbols. The REGs on all the symbols, that is, symbols #0-#8, may be numbered in a manner that frequency domain resources are numbered followed by time domain resources. That is to say, the REGs on symbol #0 are numbered according to an order from low to high in a frequency domain to obtain REG #0-REG #5; the REGs on symbol #1 are numbered according to an order from low to high in a frequency domain to obtain REG #6-REG #11, the REGs on symbol #2 are numbered according to an order from low to high in a frequency domain to obtain REG #12-REG #17, and so on, and finally the REGs on symbol #8 are numbered according to an order from low to high in a frequency domain to obtain REG #48-REG #53.

In the example of the disclosure, the REGs in the CORESET are numbered using one of candidate numbering rules 1, 2, 3, and 4.

In implementations, a plurality of mapping rules may be included. The mapping rule corresponding to the REG may be determined through a protocol agreement or a network indication. Based on the mapping rule, mapping is performed according to the sequence of the REG numbers to obtain one or more REG bundles. In some examples, after the one or more REG is obtained, the REG may also be numbered and identified.

In some examples, there may be a corresponding relation between the numbering rules and the mapping rules. After one rule is determined, the other rule may be determined.

For example, the REG bundle occupies 3 REGs, the time domain length of the time unit is 3, and 4 RBs are occupied in a frequency domain. In a case that the REGs are numbered according to the candidate numbering rule 2 and grouped according to a number sequence, 12 REG bundles may be obtained, as shown in Table 2 below, including bundle #0-bundle #11.

TABLE 2

| | | |
|---|---|---|
| bundle #3 | bundle #4 | bundle #11 |
| bundle #2 | bundle #5 | bundle #10 |
| bundle #1 | bundle #6 | bundle #9 |
| bundle #0 | bundle #7 | bundle #8 |

In a case that the REGs are numbered according to the candidate numbering rule 1 and grouped according to a number sequence, 12 REG bundles may be obtained, as shown in Table 3 below, including bundle #0-bundle #11.

TABLE 3

| | | |
|---|---|---|
| bundle #3 | bundle #7 | bundle #11 |
| bundle #2 | bundle #6 | bundle #10 |
| bundle #1 | bundle #5 | bundle #9 |
| bundle #0 | bundle #4 | bundle #8 |

In some examples, in a case that the granularity of the REG bundles is updated, 6 consecutive REGs may also be divided into one REG bundle. For another example, 8 consecutive REGs may be divided into one REG bundle. In some examples, after the one or more REG bundles are obtained, the REG bundles may also be numbered and identified.

S34, a CCE is obtained by performing resource mapping on the one or more REG bundles, so as to receive a PDCCH transmitted from the network device.

There are a plurality of candidate PDCCHs in implementations, and each candidate PDCCH may correspond to one or more different CCEs. The terminal may receive configurations of the CORESET and a search space transmitted from the network device, determine positions of the plurality of candidate PDCCHs according to the two configurations, and attempt to perform PDCCH blind detection on a plurality of candidate PDCCH channels. The candidate PDCCH channel that succeeds at last during the blind detection is the channel for transmitting the PDCCH.

In some implementations, the REG bundles may be mapped to the CCEs in a non-interleaving manner. As shown in Table 2, REG bundles #0-#3 are mapped to CCE #0 directly, REG bundles #4-#7 are mapped to CCE #1 directly, and REG bundles #8-#11 are mapped to CCE #2 directly.

In some other implementations, the REG bundles in Table 2 may be mapped to the CCEs in an interleaving manner. For example, assuming that a number of rows of interleaver is 3, after the REG bundles are interleaved, it may be determined that a mapping relation between the CCEs and the REG bundles is:
{Bundle #0, 4}->CCE #0, {Bundle #8, 1}->CCE #1, {Bundle #5, 9}->CCE #2, {Bundle #2, 6}->CCE #3, {Bundle #10, 3}->CCE #4, and {Bundle #7, 11}->CCE #5. Based on the mapping relation, it can be determined that a same CCE may have different frequency domain resources, such that more diversity gain in a frequency domain can be obtained.

It may be noted that when the REGs in the CORESET are numbered according to the candidate numbering rule 1 or the candidate numbering rule 2, a process of mapping the REG bundles to the CCEs by interleaving may include:
whenever the numbering of REGs within one time unit is completed, the REGs within the one time unit are mapped into one or more REG bundles, and one or more CCEs are obtained by performing resource mapping on the one or more REG bundles. After the one or more REG bundles within the one time unit are mapped to the CCE, REGs in the next time unit are numbered, and a subsequent mapping process is performed. That is to say, when interleaving from the REGs to the CCEs is executed, interleaving may be completed in one time unit first, and after interleaving is completed in the time unit, interleaving may be continued to be completed in the next time unit in sequence, such that transmission of a PDCCH can be quickly completed by using a shorter number of symbols when a needed aggregation level is low, and decoding delay of the PDCCH can be shortened.

In some examples, the REG bundles on all the symbols may also be interleaved together, which can obtain more diversity gain in a time domain. In some examples, the network device may configure a specific interleaving method according to service delay requirements and the configured aggregation level, and indicate the interleaving method to the terminal. It may be noted that interleaving in one time unit may satisfy that the number of columns C of the interleaver is an integer.

In the example of the disclosure, a CORESET configured by a network device is obtained, where the CORESET includes REG, and a first symbol length occupied by the CORESET is greater than 3; a REG number is determined, and the REG is mapped into one or more REG bundles according to the REG number and granularity of the REG bundles; and a CCE is obtained by performing resource mapping on the one or more REG bundles, so as to receive a PDCCH transmitted from the network device. In the example of the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved. Further, more diverse numbering manners and mapping rules are provided, flexibility of mapping the REG bundles to the CCE is improved, an aggregation degree of the CCE is further improved, and diversity gain in a time domain and/or a frequency domain is advantageously obtained.

With reference to FIG. 8, FIG. 8 is a schematic flowchart of a transmitting method for PDCCH according to an example of the disclosure. The method is executed by a terminal. As shown in FIG. 8, the method may include, but is not limited to:

S81, a CORESET configured by a network device is obtained, where the CORESET includes a REG, and a first symbol length occupied by the CORESET is greater than 3.

Any implementation in various examples of the disclosure may be used as an implementation of S81, and details are omitted here.

S82, frequency domain resources corresponding to time units included in the CORESET are determined according to indication information of the network device.

The numbers of frequency domain resources corresponding to different time units may be different or not.

In some examples, the CORESET may include K time units. K is a positive integer greater than or equal to 1. For specific description and a determining manner for the time unit, reference may be made to description of relevant contents in the above examples, and details are omitted here.

In some examples, first indication information transmitted from the network device is received, where the first indication information is configured to indicate that first L time units in K time units have a first number of frequency domain resources, remaining K-L time units have a second number of frequency domain resources, and L is greater than or equal to 1. For example, the CORESET includes 3 time units. The first indication information may indicate that first two time units 0 and 1 have 6 RBs frequency domain resources, and time unit 2 has 12 RBs frequency domain resources. Alternatively, the first indication information may indicate that time unit 0 has 12 RBs frequency domain resources, and time unit 1 and 2 have 6 RBs frequency domain resources.

In some examples, second indication information transmitted from the network device is received, where the second indication information is configured to indicate that a number of frequency domain resources is same or different for each of the time units in the K time units. For example, the CORESET includes 3 time units. The second indication information may indicate that each of the 3 time units has 6 RBs frequency domain resources. Alternatively, the second indication information may indicate that time unit 0 has 6 RBs frequency domain resources, time unit 1 has 6 RBs frequency domain resources, and time unit 3 has 24 RBs frequency domain resources.

In some examples, a total number of the REGs and start positions of the REGs indicated by the network device are received, and the frequency domain resources in the time units are determined according to the total number of the REGs and the start positions. It may be noted that the REGs in one slot need to be numbered in advance, and the REGs included in the CORESET need to be determined according to the total number of the REGs and the start positions of the REGs. In some implementations, the total number of the REGs and the start positions of the REGs may be indicated separately or indicated by joint coding.

S83, a numbering rule and a REG bundle mapping rule corresponding to the CORESET are determined.

S84, a REG number is determined according to the numbering rule, the REG is mapped according to the mapping rule, and one or more REG bundles are obtained.

S85, a CCE is obtained by performing resource mapping on the one or more REG bundles, so as to receive a PDCCH transmitted from the network device.

Any implementation in various examples of the disclosure may be used as an implementation of S83-S85, and details are omitted here.

In the example of the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved. Further, more diverse numbering manners and mapping rules are provided, flexibility of mapping the REG bundles to the CCE is improved, an aggregation degree of the CCE is further improved, and diversity gain in a time domain and/or a frequency domain is advantageously obtained.

With reference to FIG. 9, FIG. 9 is a schematic flowchart of a transmitting method for PDCCH according to an example of the disclosure. The method is executed by a terminal. As shown in FIG. 9, the method may include, but is not limited to:

S91, a CORESET configured by a network device is obtained, where the CORESET includes a REG, and a first symbol length occupied by the CORESET is greater than 3.

Any implementation in various examples of the disclosure may be used as an implementation of S91, and details are omitted here.

S92, second granularity of REG bundles and/or a number of REGs occupied by a CCE is determined according to the first symbol length.

In some examples, it is determined that the second granularity is the same as the first symbol length, that is, the newly added second granularity of the REG bundles is consistent with the newly added first symbol length of the CORESET.

In some examples, the second granularity is an integer multiple of the first symbol length. For example, a value of the first symbol length is {4, 6, 12}. When the first symbol length is 4, a value of the second granularity may be {4, 8, 12}. For another example, the value of the first symbol length is an integer multiple of 6, the value of the first symbol length is {6, 12}, and when the first symbol length is 6, the value of the second granularity may be {6, 12}.

It may be noted that when the granularity of the REG bundle is 6 REGs, in a case that the REG bundle is mapped to a CCE, and the value of the first symbol length is 6, one REG bundle corresponds to one CCE. When the value of the first symbol length is 12, one REG bundle corresponds to two CCEs with adjacent numbers. When a value of the REG bundle is 12, a configuration condition needs to satisfy a requirement that two CCEs in one REG bundle are mapped to a same candidate PDCCH.

In some examples, a number of REGs occupied by the CCE may be determined according to the first symbol length. For example, in a case that the first symbol length is 4 or 8, the CCE may occupy 8 REGs. In a case that the first symbol length is the second symbol length, the number of resources occupied by one CCE is determined to be 6 REGs.

S93, a numbering rule and a REG bundle mapping rule corresponding to the CORESET are determined.

S94, a REG number is determined according to the numbering rule, the REG is mapped according to the mapping rule, and one or more REG bundles are obtained.

S95, a CCE is obtained by performing resource mapping on the one or more REG bundles.

Any implementation in various examples of the disclosure may be used as an implementation of S93-S95, and details are omitted here.

S96, a monitoring start symbol corresponding to the PDCCH and a transmission symbol for the PDCCH are determined, and the PDCCH transmitted from the network device is received according to the monitoring start symbol and the transmission symbol for the PDCCH.

In the example of the disclosure, increasing the time domain symbol length of the CORESET will influence determination of monitoring occasions and transmission start symbols of a physical downlink channel, such as a physical downlink shared channel (PDSCH) and/or a PDCCH.

In some examples, the monitoring start symbol corresponding to the PDCCH is determined according to the first symbol length. In the disclosure, it is determined that the monitoring start symbol is the same as a symbol occupied by a start symbol 0 within the CORESET, and the first symbol length may be determined as a persistence symbol length for monitoring the PDCCH.

In some examples, in response to scheduling a PDSCH in a same slot, when the PDSCH scheduled by downlink control information (DCI) format 1-2, and a mapping type of a time domain resource of the PDSCH is mapping type B (Type B), in a case that a specific field (reference Of SLIVorDCI-Format1-2-r16 field) is configured by a higher layer, the transmission start symbol for the PDSCH has a certain offset relative to a monitoring start symbol corresponding to the monitoring occasion of the PDCCH.

In some examples, in a case of scheduling a PDSCH in a same slot, a transmission symbol for the PDSCH is determined according to a mapping type of the PDSCH. In response to the mapping type of the PDSCH being mapping type A (Type A), it is determined that the PDCCH is transmitted on N symbols occupied by the CORESET. N is a maximum symbol length of the CORESET supported. In response to the mapping type of the PDSCH being mapping type B (Type B), it is determined that a transmission start symbol for the PDSCH is not earlier than a monitoring start symbol for the PDCCH.

When the monitoring symbol of the PDCCH and the transmission symbol for the PDCCH are determined, blind detection may be performed on the PDCCH starting from the monitoring symbol of the PDCCH, and the PDCCH transmitted from the network device may be received on the transmission symbol for the PDCCH.

In the example of the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved. Further, more diverse numbering manners and mapping rules are provided, flexibility of mapping the REG bundles to the CCE is improved, an aggregation degree of the CCE is further improved, and diversity gain in a time domain and/or a frequency domain is advantageously obtained.

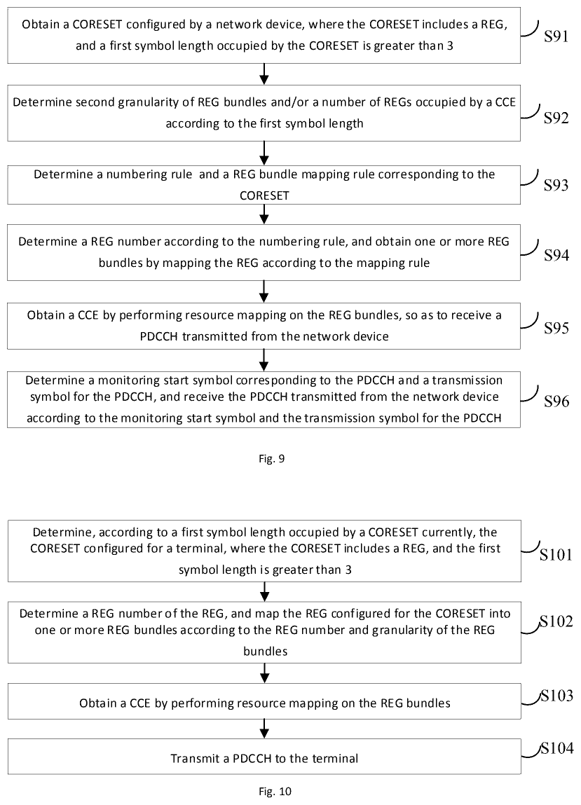

With reference to FIG. 10, FIG. 10 is a schematic flowchart of a transmitting method for PDCCH according to an example of the disclosure. The method is executed by a network device. As shown in FIG. 10, the method may include, but is not limited to:

S101, a CORESET configured for a terminal is determined according to a first symbol length occupied by the CORESET currently, where the CORESET includes a REG, and the first symbol length is greater than 3.

In order to support a Redcap terminal in transmitting a PDCCH by using as many resources as possible to enhance coverage, in the example of the disclosure, the symbol length of the CORESET may be increased to increase the number of REGs configured in the CORESET, such that a higher AL can be supported.

In the example of the disclosure, the network device may configure a plurality of first symbol lengths, and select one of them as the first symbol length occupied by the CORESET. Since the first symbol length occupied by the CORESET is greater than 3, the number of symbols occupied by the CORESET and the number of the REGs are correspondingly increased.

The network device configures the CORESET to the terminal through higher layer signaling. For example, the network device may configure the CORESET to the terminal through RRC signaling, MAC-CE signaling, SIB1 or other higher layer signaling.

In some examples, the network device indicates the first symbol length and/or the number of RBs to the terminal. For a process that the network device indicates the first symbol length and/or the number of RBs, reference may be made to description of relevant contents in the above examples, and details are omitted here.

In some examples, the frequency domain resources corresponding to each time unit included in the CORESET may be the same or not.

S102, a REG number of the REG is determined, and the REG configured for the CORESET is mapped into one or more REG bundles according to the REG number and granularity of the REG bundles.

After the CORESET is obtained, the REGs in the CORESET may be numbered. In implementations, a plurality of candidate numbering rules may be included. A REG numbering rule corresponding to the CORESET may be determined from the plurality of candidate numbering rules. Further, the network device obtains the REG number of each REG by numbering the REGs in the CORESET according to the determined numbering rule.

In some examples, the numbering rule of the REGs may be determined from two dimensions of a frequency domain and a time domain. For example, the numbering rule may be determined in a manner that time domain resources are numbered followed by frequency domain resources or a manner that frequency domain resources are numbered followed by time domain resources. Alternatively, the REGs in the CORESET may be grouped, and different numbering rules may be used for different groups.

After the REG numbers are obtained, the REGs in the CORESET may be mapped to obtain one or more REG bundles, that is, the REGs in the CORESET are divided into one or more REG bundles. One REG bundle includes several REGs consecutive in a time domain and/or a frequency domain.

In some examples, the one or more REG bundles are obtained by mapping a REG packet according to a sequence of the REG number based on original first granularity of the REG bundles. For example, the original first granularity of the REG bundles may be {2, 3, 6}. That is to say, the terminal numbers the REGs according to the existing supportable second symbol length/the number of the second symbols of the CORESET in a manner that time domain resources are numbered followed by frequency domain resources, that is, continues to number REGs on a newly added symbol based on the current REG numbers. After numbering is completed, the REG packets are mapped according to a sequence of the REG numbers to obtain the REG bundles.

It may be noted that without changing original basic granularity, that is, the first granularity, of the REG bundles, the first granularity of the REG bundles and the newly added first symbol length (except 1, 2, and 3) may satisfy the following relation: a modulus obtained by the configured first symbol length mod the first granularity is equal to 0. That is to say, possible values of the newly added first symbol length may include one or more of {6, 8, 9, 10, 12, 14}.

In the disclosure, after the first symbol length of the CORESET is increased, and the updated second granularity of the REG bundles may be obtained by increasing the granularity of the REG bundles. In some examples, the one or more REG bundles may be obtained by mapping a REG packet according to a sequence of the REG number based on the updated second granularity of the REG bundles. For example, the second granularity of the REG bundles may be {4, 8, etc.}. It may be noted that after part of the second granularity is added, the granularity of the REG bundles may be {2, 3, 4, 6, 8, etc.}.

In implementations, a plurality of candidate mapping rules may be included. The mapping rule corresponding to the REG may be determined from the plurality of candidate mapping rules. Based on the mapping rule, the network device performs mapping according to the sequence of the REG numbers, so as to obtain one or more REG bundles. For example, 6 consecutive REGs may be divided into one REG bundle, and another example, 8 consecutive REGs may be divided into one REG bundle. In some examples, after the one or more REG bundles are obtained, the REG bundles may also be numbered and identified.

In some examples, there may be a corresponding relation between the numbering rules and the mapping rules. After one rule is determined, the other rule may be determined.

S103, a CCE is obtained by performing resource mapping on the one or more REG bundles.

In some examples, after the one or more REG bundle is obtained, the REG bundle may be mapped to the CCE in an interleaving or non-interleaving manner for the REG bundle.

S104, a PDCCH is transmitted to the terminal.

There are a plurality of candidate PDCCHs in implementations, and each candidate PDCCH may correspond to one or more different CCEs. The network device may transmit configurations of the CORESET and a search space to the terminal, determine positions of the plurality of candidate PDCCHs according to the two configurations, and transmit a PDCCH on one of candidate PDCCH. The terminal performs PDCCH blind detection on the positions of the plurality of candidate PDCCHs, and determines the candidate PDCCH channel that succeeds at last during the blind detection as the channel for transmitting the PDCCH.

In the example of the disclosure, the CORESET configured for a terminal is determined according to the first symbol length occupied by the CORESET currently, where the CORESET includes a REG, and the first symbol length is greater than 3; a REG number of the REG is determined, and the REG is mapped into one or more REG bundles according to the REG number and granularity of the REG bundles; and a CCE is obtained by performing resource mapping on one or more REG bundles; and a PDCCH is transmitted to the terminal. In the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved.

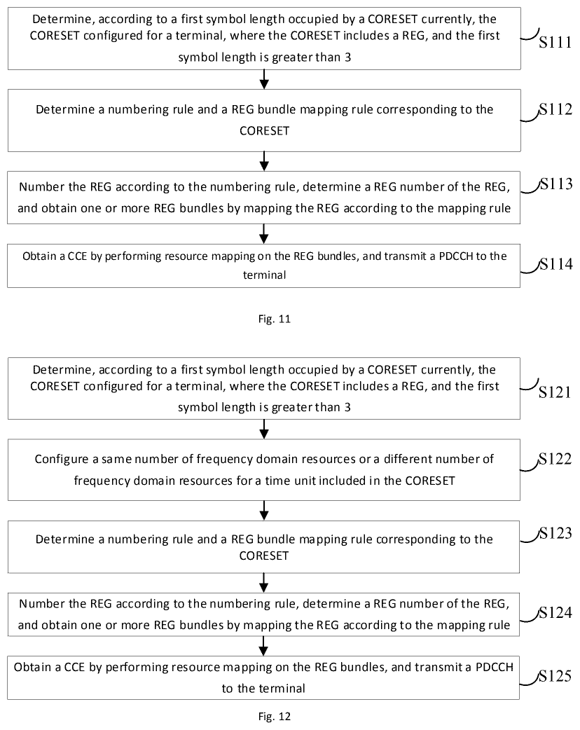

With reference to FIG. 11, FIG. 11 is a schematic flowchart of a transmitting method for PDCCH according to an example of the disclosure. The method is executed by a network device. As shown in FIG. 11, the method may include, but is not limited to:

S111, a CORESET configured for a terminal is determined according to a first symbol length occupied by the CORESET currently, where the CORESET includes a REG, and the first symbol length is greater than 3.

Any implementation in various examples of the disclosure may be used as an implementation of S111, and details are omitted here.

S112, a numbering rule and a REG bundle mapping rule corresponding to the CORESET are determined.

S113, the REG is numbered according to the numbering rule, a REG number of the REG is determined, and one or more REG bundles are obtained by mapping the REG according to the mapping rule.

In implementations, a plurality of candidate numbering rules and a plurality of candidate mapping relations may be included.

In some examples, candidate numbering rule 1: the CORESET includes K time units, the K time units are sorted in a time sequence, and the REGs within each time unit are numbered in a manner that time domain resources are numbered followed by frequency domain resources, where K is a positive integer greater than or equal to 2, and the time unit includes one or more symbols.

Alternatively, candidate numbering rule 2: the CORESET includes K time units, and the K time units are sorted in a time sequence, where K is a positive integer greater than or equal to 2. REGs within odd-numbered time units among the K time units are numbered in a manner that time domain resources are numbered followed by frequency domain resources and the frequency domain resources are numbered in reverse order. REGs within even-numbered time units among the K time units are numbered in a manner that time domain resources are numbered followed by frequency domain resources and the frequency domain resources are numbered in sequential order.

It may be noted that when the REGs within odd-numbered time units are numbered according to the candidate numbering rule 1 and the candidate numbering rule 2, although the numbers in the time units are the same, the REGs corresponding to a same number may have different corresponding frequency domain positions.

It may be noted that the CORESET includes a time domain length of the time unit, that is, the number of symbols included in the time unit can be determined according to the newly added first symbol length and the original second symbol length of the CORESET.

In some examples, an original symbol length set of the CORESET is determined, where the original symbol length set includes at least one original second symbol length. It is determined that the first symbol length is divisible by one and only one second symbol length in the symbol length set, and the one and only one second symbol length is determined as the time domain length of the time unit; it is determined that the first symbol length is divisible by all the second symbol lengths in the symbol length set, one of the second symbol lengths is determined as the time domain length of the time unit; and it is determined that the first symbol length is indivisible by any one of the second symbol lengths, 1 is determined as the time domain length of the time unit, and alternatively, the first symbol length is adjusted until the first symbol length is divisible by one of the second symbol lengths.

In some examples, candidate numbering rule 3: REGs on all symbols occupied by the CORESET are numbered in a manner that time domain resources are numbered followed by frequency domain resources.

In some examples, candidate numbering rule 4: REGs on all symbols occupied by the CORESET are numbered in a manner that frequency domain resources are numbered followed by time domain resources.

In the example of the disclosure, a numbering rule may be selected from the plurality of numbering rules, and the REGs are numbered according to the selected numbering rule. Further, a mapping rule is selected from the plurality of candidate mapping rules, and the REGs are mapped according to the selected mapping rule.

In some examples, the network device indicates the numbering rule and/or the mapping rule to the terminal. For example, the numbering rule and the mapping rule may be indicated simultaneously, and the numbering rule or the mapping rule may also be indicated separately. In some examples, there may be a corresponding relation between the numbering rules and the mapping rules. After one rule is determined, the other rule may be determined.

S114, a CCE is obtained by performing resource mapping on the one or more REG bundles, and a PDCCH is transmitted to the terminal.

In some examples, after the one or more REG bundle is obtained, the REG bundle may be mapped to the CCE in an interleaving or non-interleaving manner for the REG bundle. There are a plurality of candidate PDCCHs in implementations, and each candidate PDCCH may correspond to one or more different CCEs. The network device may transmit configurations of the CORESET and a search space to the terminal, determine positions of the plurality of candidate PDCCHs according to the two configurations, and transmit a PDCCH on one of candidate PDCCH. The terminal performs PDCCH blind detection on the positions of the plurality of candidate PDCCHs, and determines the candidate PDCCH channel that succeeds at last during the blind detection as the channel for transmitting the PDCCH.

In some implementations, the REG bundles may be mapped to the CCEs in a non-interleaving manner. As shown in Table 2, REG bundles #0-#3 are mapped to CCE #0 directly, REG bundles #4-#7 are mapped to CCE #1 directly, and REG bundles #8-#11 are mapped to CCE #2 directly.

In some other implementations, the REG bundles in Table 2 may be mapped to the CCEs in an interleaving manner. After the one or more REG bundles are interleaved, it may be determined that a mapping relation between the CCEs and the REG bundles is:
{Bundle #0, 4}->CCE #0, {8, 1}->CCE #1, {5, 9}->CCE #2, {2, 6}->CCE #3, {10, 3}->CCE #4, and {7, 11}->CCE #5. Based on the mapping relation, it can be determined that a same CCE may have different frequency domain resources, such that more diversity gain in a frequency domain can be obtained.

It may be noted that when the REGs in the CORESET are numbered according to the candidate numbering rule 1 or the candidate numbering rule 2, a process of mapping the REG bundles to the CCEs by interleaving may include:
whenever the numbering of REGs within one time unit is completed, the REGs within the one time unit are mapped into one or more REG bundles, and one or more CCEs are obtained by performing resource mapping on the one or more REG bundles. After the one or more REG bundles within the one time unit are mapped to the CCE is completed, then REGs in a next time unit are numbered, and a subsequent mapping process is performed. That is to say, when interleaving from the REGs to the CCEs is executed, interleaving may be completed in one time unit first, and after interleaving is completed in the time unit, interleaving may be continued to be completed in the next time unit in sequence, such that transmission of a PDCCH can be quickly completed by using a shorter number of symbols when a needed aggregation level is low, and decoding delay of the PDCCH can be shortened.

In some examples, the REG bundles on all the symbols may also be interleaved together, which can obtain more diversity gain in a time domain. In some examples, the network device may configure a specific interleaving method according to service delay requirements and the configured aggregation level, and indicate the interleaving method to the terminal. It may be noted that interleaving in one time unit may satisfy that the number of columns C of the interleavers is an integer.

In the example of the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved. Further, more diverse numbering manners and mapping rules are provided, flexibility of mapping the REG bundles to the CCE is improved, an aggregation degree of the CCE is further improved, and diversity gain in a time domain and/or a frequency domain is advantageously obtained.

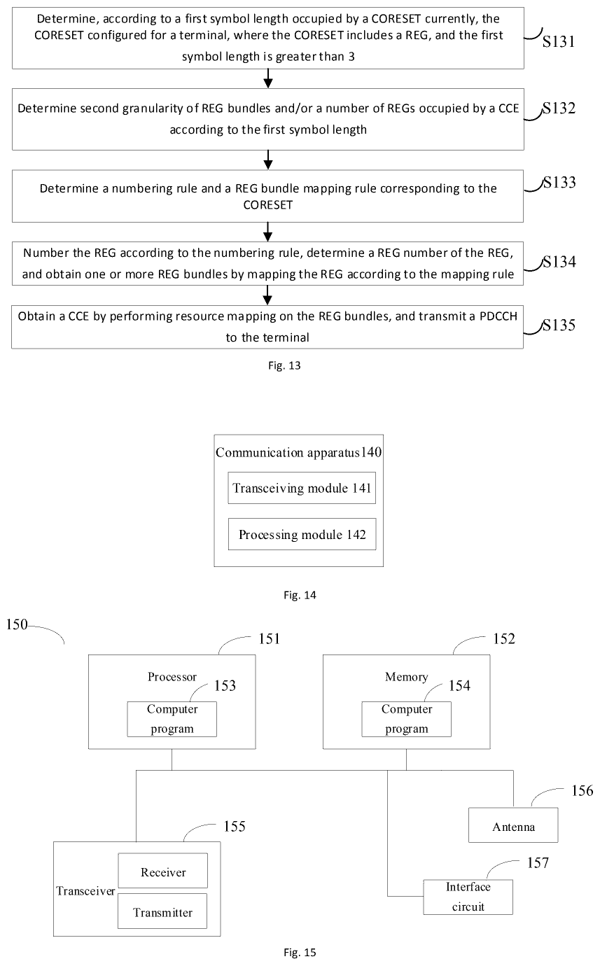

With reference to FIG. 12, FIG. 12 is a schematic flowchart of a transmitting method for PDCCH according to an example of the disclosure. The method is executed by a network device. As shown in FIG. 12, the method may include, but is not limited to:

S121, a CORESET configured for a terminal is determined according to a first symbol length occupied by the CORESET currently, where the CORESET includes a REG, and the first symbol length is greater than 3.

Any implementation in various examples of the disclosure may be used as an implementation of S121, and details are omitted here.

S122, a same number of frequency domain resources or a different number of frequency domain resources are configured for a time unit included in the CORESET.

In some examples, the CORESET may include K time units. K is a positive integer greater than or equal to 1. For specific description and a determining manner for the time unit, reference may be made to description of relevant contents in the above examples, and details are omitted here.

In some examples, first L time units in K time units included in the CORESET are provided with a first number of frequency domain resources, the remaining K-L time units are provided with a second number of frequency domain resources, and L is greater than or equal to 1.

In some examples, a same number of frequency domain resources are configured for each time unit in K time units included in the CORESET. Alternatively, a different number of frequency domain resources are configured for each time unit in K time units included in the CORESET.

In some examples, a total number of the REGs and start positions of the REGs are determined, and the frequency domain resources in the time units are determined according to the total number of the REGs and the start positions. It may be noted that the REGs in one slot need to be numbered in advance, and the REGs included in the CORESET need to be determined according to the total number of the REGs and the start positions of the REGs. In some implementations, the total number of the REGs and the start positions of the REGs may be indicated separately or indicated by joint coding.

In some examples, the network device transmits instruction information to the terminal, where the instruction information is configured to instruct the terminal to determine frequency domain resources corresponding to time units included in the CORESET.

In some examples, first indication information is transmitted from the network device to the terminal, where the first indication information is configured to indicate that first L time units in K time units have a first number of frequency domain resources, remaining K-L time units have a second number of frequency domain resources, and L is greater than or equal to 1.

In some examples, second indication information is transmitted from the network device to the terminal, where the second indication information is configured to indicate that a number of frequency domain resources is same or different for each of the time units in the K time units.

In some examples, the network device indicates the total number of the REGs and the start positions of the REGs to the terminal. In some implementations, the total number of the REGs and the start positions of the REGs may be indicated separately or indicated by joint coding.

S123, a numbering rule and a REG bundle mapping rule corresponding to the CORESET are determined.

S124, a REG number of the REG is determined according to the numbering rule, the REG is mapped according to the REG bundle mapping rule, and one or more REG bundles are obtained.

S125, a CCE is obtained by performing resource mapping on the one or more REG bundles, and a PDCCH is transmitted to the terminal.

Any implementation in various examples of the disclosure may be used as an implementation of S123-S125, and details are omitted here.

In the example of the disclosure, a capacity of the CORESET is expanded by increasing the symbol length of the CORESET, and a higher aggregation degree of the CCE is obtained by mapping the REG bundles to the CCE, such that transmission reliability of the PDCCH is improved. Further, more diverse numbering manners and mapping rules are provided, flexibility of mapping the REG bundles to the CCE is improved, an aggregation degree of the CCE is further improved, and diversity gain in a time domain and/or a frequency domain is advantageously obtained.

With reference to FIG. 13, FIG. 13 is a schematic flowchart of a transmitting method for PDCCH according to an example of the disclosure. The method is executed by a network device. As shown in FIG. 13, the method may include, but is not limited to:

S131, a CORESET configured for a terminal is determined according to a first symbol length occupied by the CORESET currently, where the CORESET includes a REG, and the first symbol length is greater than 3.

Any implementation in various examples of the disclosure may be used as an implementation of S131, and details are omitted here.

S132, second granularity of REG bundles and/or a number of REGs occupied by a CCE is determined according to the first symbol length.

In some examples, it is determined that the second granularity is the same as the first symbol length, that is, the newly added second granularity of the REG bundles is consistent with the newly added first symbol length of the CORESET.

In some examples, the second granularity is an integer multiple of the first symbol length. For example, a value of the first symbol length is {4, 6, 12}. When the first symbol length is 4, a value of the second granularity may be {4, 8, 12}. For another example, the value of the first symbol length is an integer multiple of 6, then the value of the first symbol length is {6, 12}, and when the first symbol length is 6, the value of the second granularity may be {6, 12}.

In some examples, a number of REGs occupied by the CCE may be determined according to the first symbol length. For example, in a case that the first symbol length is 4 or 8, the CCE may occupy 8 REGs. In a case that the first symbol length is the second symbol length, the number of resources occupied by one CCE is determined to be 6 REGs.

It may be noted that when the granularity of the REG bundle is 6 REGs, in a case that the REG bundle is mapped to a CCE, and the value of the first symbol length is 6, one REG bundle corresponds to one CCE. When the value of the first symbol length is 12, one REG bundle corresponds to two CCEs with adjacent numbers. When a value of the REG bundle is 12, a configuration condition needs to satisfy a requirement that two CCEs in one REG bundle are mapped to a same candidate PDCCH.

S133, a numbering rule and a REG bundle mapping rule corresponding to the CORESET are determined.

S134, a REG number of the REG is determined according to the numbering rule, the REG is mapped according to the mapping rule, and one or more REG bundles are obtained.

S135, a CCE is obtained by performing resource mapping on the one or more REG bundles, and a PDCCH is transmitted to the terminal.

Any implementation in various examples of the disclosure may be used as an implementation of S133-S135, and details are omitted here.

In the example of the disclosure, increasing the time domain symbol length of the CORESET will influence determination of monitoring occasions and transmission start symbols of a physical downlink channel, such as a physical downlink shared channel (PDSCH) and/or a PDCCH.

In some examples, the monitoring start symbol corresponding to the PDCCH is determined according to the first symbol length. In the disclosure, it is determined that the monitoring start symbol is the same as a symbol occupied by a start symbol 0 within the CORESET, and the first symbol length may be determined as a persistence symbol length for monitoring the PDCCH.

In some examples, in response to scheduling a PDSCH in a same slot, when the PDSCH scheduled by downlink control information (DCI) format 1-2, and a mapping type of a time domain resource of the PDSCH is mapping type B (Type B), in a case that a specific field (reference Of SLIVorDCI-Format1-2-r16 field) is configured by a higher layer, the transmission start symbol for the PDSCH has a certain offset relative to a monitoring start symbol corresponding to the monitoring occasion of the PDCCH.

In some examples, in a case of scheduling a PDSCH in a same slot, a transmission symbol for the PDSCH is determined according to a mapping type of the PDSCH. In response to the mapping type of the PDSCH being mapping type A (Type A), it is determined that the PDCCH is transmitted on N symbols occupied by the CORESET. N is a maximum symbol length of the CORESET supported. In response to the mapping type of the PDSCH being mapping type B (Type B), it is determined that a transmission start symbol for the PDSCH is not earlier than a monitoring start symbol for the PDCCH.

Further, the network device may start transmitting the PDCCH to the terminal on a transmission symbol occupied by one of the plurality of candidate PDCCH on the CORESET.

In the example of the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved. Further, more diverse numbering manners and mapping rules are provided, flexibility of mapping the REG bundles to the CCE is improved, an aggregation degree of the CCE is further improved, and diversity gain in a time domain and/or a frequency domain is advantageously obtained.

In the above examples provided in the disclosure, the method provided by the examples of the disclosure is introduced from the perspectives of a network device and a terminal separately. In order to implement functions in the method provided in the above examples of the disclosure, the network device and the terminal may include a hardware structure and a software module. The above functions are implemented in a form of a hardware structure, a software module, or a hardware structure and a software module. Any one of the above functions may be executed by a hardware structure, a software module, or a hardware structure and a software module.

With reference to FIG. 14, a schematic structural diagram of a communication apparatus 140 according to an example of the disclosure is provided. The communication apparatus 140 shown in FIG. 14 may include a transceiving module 141 and a processing module 142. The transceiving module 141 may include a transmitting module and/or a receiving module. The transmitting module is configured to implement a transmitting function. The receiving module is configured to implement a receiving function. The transceiving module 141 may implement the transmitting function and/or the receiving function.

The communication apparatus 140 may be a terminal (such as the terminal in the foregoing method example), an apparatus in the terminal, or an apparatus that can be used in conjunction with the terminal. Alternatively, the communication apparatus 140 may be a network device, an apparatus in a network device, or an apparatus that can be used in conjunction with the network device.

The communication apparatus 140 may be a terminal (such as the terminal in the foregoing method example), and includes:
a processing module 142 configured to obtain a control resource set (CORESET) configured by a network device, where the CORESET includes a resource element group (REG), and a first symbol length occupied by the CORESET is greater than 3; determine a REG number of the REG, and map the REG into one or more REG bundles according to the REG number and granularity of the REG bundles; and obtain a control channel element (CCE) by performing resource mapping on the one or more REG bundles, so as to receive a PDCCH transmitted from the network device; and
a transceiving module 141 configured to receive the PDCCH transmitted from the network device.

In some examples, the processing module 142 is further configured to determine a numbering rule and a REG bundle mapping rule corresponding to the CORESET according to a protocol agreement or a network indication, number the REG according to the numbering rule, and map the REG according to the mapping rule.

In some examples, the processing module 142 is further configured to:
obtain the one or more REG bundles by mapping the REG packet according to a sequence of the REG number based on original first granularity of the REG bundles; and alternatively,
obtain the one or more REG bundles by mapping the REG packet according to a sequence of the REG number based on updated second granularity of the REG bundles.

In some examples, the processing module 142 is further configured to number REGs within the K time units in a time sequence in a case that the CORESET includes K time units, and number the REGs within each time unit in a manner that time domain resources are numbered followed by frequency domain resources, where K is a positive integer greater than or equal to 2, and the time unit includes one or more symbols.

In some examples, the processing module 142 is further configured to:
number REGs within the K time units in a time sequence in a case that the CORESET includes K time units, where K is a positive integer greater than or equal to 2;
number REGs within odd-numbered time units among the K time units in a manner that time domain resources are numbered followed by frequency domain resources and the frequency domain resources are numbered in reverse order; and
number REGs within even-numbered time units among the K time units in a manner that time domain resources are numbered followed by frequency domain resources and the frequency domain resources are numbered in sequential order.

In some examples, the processing module 142 is further configured to:
map, whenever the numbering of REGs within one time unit is completed, the REGs within the one time unit into one or more REG bundles, and obtain the CCE by performing the resource mapping on the one or more REG bundles; and
after the one or more REG bundles within the one time unit are mapped to the CCE, number REGs in the next time unit, and perform a subsequent mapping process.

In some examples, the processing module 142 is further configured to number REGs on all symbols occupied by the CORESET in a manner that time domain resources are numbered followed by frequency domain resources.

In some examples, the processing module 142 is further configured to number REGs on all symbols occupied by the CORESET in a manner that frequency domain resources are numbered followed by time domain resources.

In some examples, the processing module 142 is further configured to:
determine an original symbol length set of the CORESET, where the original symbol length set includes at least one second symbol length;
determine, in response to the first symbol length being divisible by one and only one second symbol length, the one and only one second symbol length as the time domain length of the time unit;
determine, in response to the first symbol length being divisible by all the second symbol lengths, one of the second symbol lengths as the time domain length of the time unit; and
determine, in response to the first symbol length being indivisible by any one of the second symbol lengths, 1 as the time domain length of the time unit, and alternatively, adjust the first symbol length until the first symbol length is divisible by one of the second symbol lengths.

In some examples, the processing module 142 is further configured to determine frequency domain resources corresponding to time units included in the CORESET according to indication information of the network device.

In some examples, the transceiving module 141 is further configured to:
receive first indication information transmitted from the network device, where the first indication information is configured to indicate that first L time units in K time units have a first number of frequency domain resources, remaining K-L time units have a second number of frequency domain resources, and L is greater than or equal to 1; and alternatively,
receive second indication information transmitted from the network device, where the second indication information is configured to indicate that a number of frequency domain resources is same or different for each of the time units in the K time units.

In some examples, the transceiving module 141 is further configured to receive a total number of the REGs and start positions of the REGs indicated by the network device.

In some examples, the processing module 142 is further configured to determine the frequency domain resources of the time units according to the total number and the start positions.

In some examples, the processing module 142 is further configured to determine the second granularity according to the first symbol length.

In some examples, the processing module 142 is further configured to determine that the second granularity is the same as the first symbol length or is an integer multiple of the first symbol length.

In some examples, the processing module 142 is further configured to determine a number of REGs occupied by the CCE according to the first symbol length.

In some examples, the processing module 142 is further configured to determine a monitoring start symbol corresponding to the PDCCH according to the first symbol length.

In some examples, the processing module 142 is further configured to determine that the monitoring start symbol is the same as a symbol occupied by a start symbol 0 within the CORESET; and determine the first symbol length as a persistence symbol length for monitoring the PDCCH.

In some examples, the processing module 142 is further configured to determine, in a case of scheduling a PDSCH in a same slot, a transmission symbol for the PDSCH or the PDCCH according to a mapping type of the PDSCH.

In some examples, the processing module 142 is further configured to determine, when the mapping type of the PDSCH is mapping type A, that the PDCCH is transmitted on N symbols occupied by the CORESET; and alternatively, determine, when the mapping type of the PDSCH is mapping type B, that a transmission start symbol for the PDSCH is not earlier than a monitoring start symbol for the PDCCH.

In some examples, the processing module 142 is further configured to determine the first symbol length and/or a number of RBs based on a protocol agreement or a network indication.

The communication apparatus 140 is a network device, and includes:
a processing module 142 configured to determine, according to a first symbol length occupied by a control resource set (CORESET) currently, the CORESET configured for a terminal, where the CORESET includes a REG, and the first symbol length is greater than 3; determine a REG number of the REG, and map the REG into one or more REG bundles according to the REG number and granularity of the REG bundles; and obtain a CCE by performing resource mapping on the one or more REG bundles; and
a transceiving module 141 configured to transmit a PDCCH to the terminal.

In some examples, the processing module 142 is further configured to determine a numbering rule and a REG bundle mapping rule corresponding to the CORESET, number the REG according to the numbering rule, determine the REG number of the REG, and obtain one or more REG bundles by mapping the REG according to the mapping rule.

In some examples, the transceiving module 141 is further configured to indicate the numbering rule and/or the mapping rule to the terminal.

In some examples, the processing module 142 is further configured to:
obtain the one or more REG bundles by mapping a REG packet according to a sequence of the REG number based on original first granularity of the REG bundles; and alternatively,
obtain the one or more REG bundles by mapping a REG packet according to a sequence of the REG number based on updated second granularity of the REG bundles.

In some examples, the processing module 142 is further configured to number REGs within the K time units in a time sequence in a case that the CORESET includes K time units, and number the REGs within each time unit in a manner that time domain resources are numbered followed by frequency domain resources, where K is a positive integer greater than or equal to 2, and the time unit includes one or more symbols.

In some examples, the processing module 142 is further configured to number REGs within the K time units in a time sequence in a case that the CORESET includes K time units, where K is a positive integer greater than or equal to 2;
number REGs within odd-numbered time units among the K time units in a manner that time domain resources are numbered followed by frequency domain resources and the frequency domain resources are numbered in reverse order; and
number REGs within even-numbered time units among the K time units in a manner that time domain resources are numbered followed by frequency domain resources and the frequency domain resources are numbered in sequential order

In some examples, the processing module 142 is further configured to map, whenever the numbering of REGs within one time unit is completed, the REGs within the one time unit into one or more REG bundles, and obtain the CCE by performing the resource mapping on the one or more REG bundles; and
after the one or more REG bundles within the one time unit are mapped to the CCE, number REGs in the next time unit, and perform a subsequent mapping process.

In some examples, the processing module 142 is further configured to number REGs on all symbols occupied by the CORESET in a manner that time domain resources are numbered followed by frequency domain resources.

In some examples, the processing module 142 is further configured to number REGs on all symbols occupied by the CORESET in a manner that frequency domain resources are numbered followed by time domain resources.

In some examples, the processing module 142 is further configured to:
determine an original symbol length set of the CORESET, where the original symbol length set includes at least one second symbol length;
determine, in response to the first symbol length being divisible by one and only one second symbol length, the one and only one second symbol length as the time domain length of the time unit;
determine, in response to the first symbol length being divisible by all the second symbol lengths, one of the second symbol lengths as the time domain length of the time unit; and
determine, in response to the first symbol length being indivisible by any one of the second symbol lengths, 1 as the time domain length of the time unit, and alternatively, adjust the first symbol length until the first symbol length is divisible by one of the second symbol lengths.

In some examples, the processing module 142 is further configured to configure a same number of frequency domain resources or a different number of frequency domain resources for a time unit included in the CORESET.

In some examples, the processing module 142 is further configured to:
configure a first number of frequency domain resources for first L time units in K time units, and configure a second number of frequency domain resources for remaining K-L time units; alternatively,
configure a different number of frequency domain resources for each time unit in the K time units; and
configure a same number of frequency domain resources for each time unit in the K time units.

In some examples, the transceiving module 141 is further configured to transmit instruction information to the terminal, where the instruction information is configured to instruct the terminal to determine frequency domain resources corresponding to time units included in the CORESET.

In some examples, the processing module 142 is further configured to determine a total number of the REGs and start positions of the REGs, and determine the frequency domain resources in the time units according to the total number and the start positions; and
indicate the total number of the REGs and the start positions of the REGs jointly or separately to the terminal.

In some examples, the processing module 142 is further configured to determine the second granularity according to the first symbol length.

In some examples, the processing module 142 is further configured to determine that the second granularity is the same as the first symbol length or is an integer multiple of the first symbol length.

In some examples, the processing module 142 is further configured to determine a number of REGs occupied by the CCE according to the first symbol length.

In some examples, the processing module 142 is further configured to determine a monitoring start symbol corresponding to the PDCCH according to the first symbol length.

In some examples, the processing module 142 is further configured to determine that the monitoring start symbol is the same as a start symbol occupied by a start symbol 0 within the CORESET; and
determine the first symbol length as a persistence symbol length for monitoring the PDCCH.

In some examples, the processing module 142 is further configured to determine, in response to scheduling a physical downlink shared channel (PDSCH) in a same slot, a transmission symbol for the PDSCH or the PDCCH according to a mapping type of the PDSCH.

In some examples, the processing module 142 is further configured to determine, when the mapping type of the PDSCH is mapping type A, that the PDCCH is transmitted on N symbols occupied by the CORESET; and alternatively, determine, when the mapping type of the PDSCH is mapping type B, that a transmission start symbol for the PDSCH is not earlier than a monitoring start symbol for the PDCCH.

In some examples, the processing module 142 is further configured to determine the first symbol length and/or a number of RBs based on a protocol agreement.

In some examples, the transceiving module 141 is further configured to indicate the first symbol length and/or the number of RBs to the terminal.

In the examples of the disclosure, a capacity of the CORESET is expanded by increasing the symbol length of the CORESET, and a higher aggregation degree of the CCE is obtained by mapping the one or more REG bundles to the CCE, such that transmission reliability of the PDCCH is improved. Further, more diverse numbering manners and mapping rules are provided, flexibility of mapping the REG bundles to the CCE is improved, an aggregation degree of the CCE is further improved, and diversity gain in a time domain and/or a frequency domain is advantageously obtained.

With reference to FIG. 15, FIG. 15 is a schematic structural diagram of another communication apparatus 150 according to an example of the disclosure. The communication apparatus 150 may be a terminal, may be a network device, may be a chip, a chip system, or a processor that supports a terminal to implement the above method, and may also be a chip, a chip system, or a processor that supports a network device to implement the above method. The communication apparatus may be configured to implement the methods described in the above method examples, and reference may be made to description in the above method examples for details.

The communication apparatus 150 may include one or more processors 151. The processor 151 may be a general purpose processor or a special purpose processor, etc., such as a baseband processor or a central processor. The baseband processor may be configured to process a communication protocol and communication data. The central processor may be configured to control a communication apparatus (for example, a base station, a baseband chip, a terminal, a terminal chip, a DU or a CU), execute a computer program, and process data of the computer program.

In some examples, the communication apparatus 150 may further include one or more memories 152 that may store a computer program 154. The processor 151 executes the computer program 154 to cause the communication apparatus 150 to execute the method described in the above method examples. In some examples, the memory 152 may also store data. The communication apparatus 150 and the memory 152 may be arranged separately or may be integrated together.

In some examples, the communication apparatus 150 may further include a transceiver 155 and an antenna 156. The transceiver 155 may be referred to as a transceiving unit, a transceiving machine, or a transceiving circuit, etc., and is configured to implement a transceiving function. The transceiver 155 may include a receiver and a transmitter. The receiver may be referred to as a receiver machine or a receiving circuit, etc., for implementing a reception function. The transmitter may be referred to as a transmitter machine or a transmitting circuit, etc., for implementing a transmission function.

In some examples, the communication apparatus 150 may further include one or more interface circuits 157. The interface circuit 157 is configured to receive a code instruction and transmit the code instruction to the processor 151. The processor 151 runs the code instruction to cause the communication apparatus 150 to execute the method described in the above method examples.

In an implementation, the processor 151 may include a transceiver for implementing a reception function and a transmission function. For example, the transceiver may be a transceiving circuit, or an interface, or an interface circuit. The transceiving circuit, interface, or interface circuit for implementing the reception function and the transmission function may be separated or integrated. The transceiving circuit, interface or interface circuit may be configured to read and write a code/data, and alternatively, the transceiving circuit, interface or interface circuit may be configured to transmit or transfer a signal.

In one implementation, the processor 151 may store a computer program 153. The computer program 153 runs on the processor 151 and causes the communication apparatus 150 to execute the method described in the method examples above. The computer program 153 may be embedded in the processor 151. In this case, the processor 151 may be implemented by hardware.

In an implementation, the communication apparatus 150 may include a circuit that may implement the functions of transmission, reception or communication in the foregoing method examples. The processor and transceiver described in the disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be fabricated by using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus described in the above example may be a transmitting device or a receiving device (such as the receiving device in the foregoing method examples), but the scope of the communication apparatus described in the disclosure is not limited to this, and a structure of the communication apparatus may not be limited by FIG. 15. The communication apparatus may be a stand-alone device or may be part of a larger device. For example, the communication apparatus may be:
(1) an independent integrated circuit (IC), a chip, a chip system or a subsystem;
(2) a set of one or more ICs, in some examples, the set of IC may also include a memory component for storing data and a computer program;
(3) an ASIC, such as a modem;
(4) a module that can be embedded in other devices;
(5) a receiver machine, a terminal, an intelligent terminal, a cellular phone, a radio device, a handset, a mobile unit, a vehicle-mounted device, a network device, a cloud device, an artificial intelligence device, etc.; and
(6) others, etc.

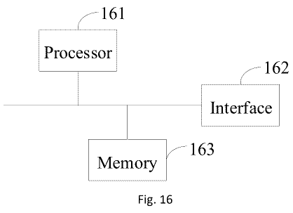

Reference may be made to a schematic structural diagram of a chip shown in FIG. 16 for the case that the communication apparatus may be a chip or a chip system. The chip shown in FIG. 16 includes a processor 161 and an interface 162. One or more processors 161 may be provided. A plurality of interfaces 162 may be provided.

In some examples, the chip further includes a memory 163. The memory 163 is configured to store a necessary computer program and data.

The chip is configured to perform the functions of any of the above method examples when executed.

Those skilled in the art will further appreciate that the various illustrative logical blocks and steps set forth in the examples of the disclosure may be implemented by electronic hardware, computer software, or combinations of both. Whether such functions are implemented by hardware or software depends on a particular application and overall system design requirements. Those skilled in the art may use various methods to implement the functions for each particular application, but such implementation may not be understood as beyond the scope of protection of the examples of the disclosure.

The examples of the disclosure further provide a communication system for transmitting a PDCCH. The system includes the communication apparatus serving as a terminal (such as the terminal in the foregoing method examples) and the communication apparatus serving as a network device in the example of FIG. 14. Alternatively, the system includes the communication apparatus serving as a terminal (such as the terminal in the device method examples) and the communication apparatus serving as a network device in the example of FIG. 15.

The disclosure further provides a non-transitory computer-readable storage medium. The non-transitory computer-readable storage medium stores an instruction. The instruction implements the functions of any one of the method examples when executed by a computer.

The disclosure further provides a computer program product. The computer program product implements the functions of the method examples when executed by a computer.

The examples described above can be implemented in whole or in part by software, hardware, firmware, or their any combinations. When implemented through the software, all or some of the modules may be implemented in the form of computer program products. The computer program product includes one or more computer programs. When loaded and executed on a computer, the computer program generates in whole or in part the flows or functions described in accordance with the examples of the disclosure. The computer may be a general-purpose computer, a special-purpose computer, a computer network, or another programmable apparatus. The computer program may be stored in a non-transitory computer-readable storage medium or transmitted from one non-transitory computer-readable storage medium to another non-transitory computer-readable storage medium. For example, the computer program can be transmitted from one website, computer, server, or data center to another website, computer, server, or data center in a mode of a wire (for example, coaxial cable, optical fiber, digital subscriber line (DSL)) or radio (for example, infrared, radio waves, and microwaves, etc.). The non-transitory computer-readable storage medium may be any available medium that can be accessed by a computer or a data storage device including one or more available media integrated as a server, data center, etc. The available medium may be a magnetic medium (for example, floppy disk, hard disk, magnetic tape), an optical medium (for example, a digital video disk (DVD)), or a semiconductor medium (for example, a solid state disk (SSD)), etc.

Those skilled in the art may understand that the first, second and other numerical numbers referred to in the disclosure are for distinction for convenience of description, instead of limiting the scope of the examples of the disclosure, and nor do they represent the order of sequence.

At least one in the disclosure may also be described as one or more, and the plurality may be two, three, four, or more, which are not limited in the disclosure. In the examples of the disclosure, for a type of technical features, technical features in this type of the technical features are distinguished by “first”, “second”, “third”, “A”, “B”, “C” and “D”, and the technical features described by the “first”, “second”, “third”, “A”, “B”, “C” and “D” are not in order of sequence or order of magnitude.

Corresponding relations shown in tables of the disclosure may be configured or predefined. Values of information in each table are instances, and may be configured differently, which is not limited in the disclosure. When a corresponding relation between the information and each parameter is configured, it is not necessarily to configure all the corresponding relations indicated in each table. For example, in the tables of the disclosure, the corresponding relations shown in some rows may not be configured. For another example, appropriate deformation adjustments, such as splitting, merging, etc., can be made based on the above table. Names of the parameters shown in the titles of the above tables may also be other names that can be understood by the communication apparatus, and values or expression modes of the parameters may also be other values or expression modes that can be understood by the communication apparatus. When the tables are implemented, other data structures may also be used, such as an array, a queue, a container, a stack, a linear table, a pointer, a linked list, a tree, a graph, a structure, a class, a heap, and a hash table.

Predefinition in the disclosure may be understood as definition, pre-definition, storage, pre-storage, pre-negotiation, pre-configuration, curing, or pre-firing.

Those of ordinary skill in the art may appreciate that the units and algorithm steps of the instances described in conjunction with the examples disclosed here may be implemented in electronic hardware, or a combination of computer software and electronic hardware. Whether these functions are performed with hardware or software depends on the specific application and design constraints of the technical solution. Those skilled in the art can use different methods to implement the described functions for each particular application, but such implementation may not be deemed as falling beyond the scope of the disclosure.

Those skilled in the art will clearly appreciate that, for convenience and conciseness of description, reference can be made to corresponding processes in the foregoing method examples for specific working processes of the above systems, apparatus and units, which are not repeated here.

What are described above are particular examples of the disclosure, and are not intended to limit the scope of protection of the disclosure, and any changes or substitutions that can readily occur to those skilled in the art within the scope of technology disclosed in the disclosure may fall within the scope of protection of the disclosure. The scope of protection of the disclosure may be subject to the scope of protection of the claims.

1. A transmitting method for physical downlink control channel (PDCCH), executed by a terminal, comprising:
obtaining a control resource set (CORESET) configured by a network device, wherein the CORESET comprises a resource element group (REG), and a first symbol length occupied by the CORESET is greater than 3;
determining a REG number of the REG, and mapping the REG into one or more REG bundles according to the REG number and granularity of the REG bundles; and
obtaining a control channel element (CCE) by performing resource mapping on the one or more REG bundles, so as to receive a PDCCH transmitted from the network device.

2. The transmitting method according to claim 1, wherein before determining the REG number of the REG, and mapping the REG into one or more REG bundles according to the REG number and the granularity of the REG bundles, further comprises:
determining a numbering rule and a REG bundle mapping rule corresponding to the CORESET according to a protocol agreement or a network indication, numbering the REG according to the numbering rule, and mapping the REG according to the REG bundle mapping rule;
wherein mapping the REG into one or more REG bundles according to the REG number and the granularity of the REG bundles comprises at least one of:
obtaining the one or more REG bundles by mapping a REG packet according to a sequence of the REG number based on original first granularity of the REG bundles; or
obtaining the one or more REG bundles by mapping a REG packet according to a sequence of the REG number based on updated second granularity of the REG bundles.

3. (canceled)

4. The transmitting method according to claim 1, wherein the CORESET comprises K time units, the K time units being REG numbered among themselves in a time sequence, wherein K is a positive integer greater than or equal to 2, and the time unit comprises one or more symbols;
wherein determining the REG number of the REG comprises at least one of:
numbering the REGs within each time unit in a manner that time domain resources are numbered followed by frequency domain resources; or
numbering REGs within odd-numbered time units among the K time units in a manner that time domain resources are numbered followed by frequency domain resources and the frequency domain resources are numbered in reverse order; or
numbering REGs within even-numbered time units among the K time units in a manner that time domain resources are numbered followed by frequency domain resources and the frequency domain resources are numbered in sequential order.

5. (canceled)

6. The transmitting method according to claim 4, wherein obtaining the control channel element (CCE) by performing the resource mapping on the one or more REG bundles comprises:
mapping, whenever the numbering of REGs within one time unit is completed, the REGs within the one time unit into one or more REG bundles, and obtaining the CCE by performing the resource mapping on the one or more REG bundles; and
after the one or more REG bundles within the one time unit are mapped to the CCE, numbering REGs within the next time unit, and performing a subsequent mapping process.

7. The transmitting method according to claim 1, wherein determining the REG number of the REG comprises at least one of:
numbering REGs on all symbols occupied by the CORESET in a manner that time domain resources are numbered followed by frequency domain resources; or
numbering REGs on all symbols occupied by the CORESET in a manner that frequency domain resources are numbered followed by time domain resources.

8. (canceled)

9. The transmitting method according to claim 4, wherein a process for determining a time domain length of the time unit comprises:
determining an original symbol length set of the CORESET, wherein the original symbol length set comprises at least one second symbol length;
determining, in response to the first symbol length being divisible by one and only one second symbol length, the one and only one second symbol length as the time domain length of the time unit;
determining, in response to the first symbol length being divisible by all the second symbol lengths, one of the second symbol lengths as the time domain length of the time unit; and
performing, in response to the first symbol length being indivisible by any one of the second symbol lengths, at least one of:
determining 1 as the time domain length of the time unit; or
adjusting the first symbol length until the first symbol length is divisible by one of the second symbol lengths.

10. The transmitting method according to claim 1, wherein the CORESET comprises K time units;
wherein obtaining the control resource set (CORESET) configured by the network device comprises at least one of:
receiving first indication information transmitted from the network device, wherein the first indication information is configured to indicate that first L time units in K time units have a first number of frequency domain resources, remaining K-L time units have a second number of frequency domain resources, and L is greater than or equal to 1; or
receiving second indication information transmitted from the network device, wherein the second indication information is configured to indicate that a number of frequency domain resources is same or different for each time unit in the K time units; or
receiving a total number of the REGs and start positions of the REGs indicated by the network device; and determining the frequency domain resources in the time unit according to the total number and the start positions.

11-12. (canceled)

13. The transmitting method according to claim 2, wherein a process for determining the second granularity of the REG bundles comprises at least one of:
determining that the second granularity is the same as the first symbol length; or
determining that the second granularity is an integer multiple of the first symbol length.

14-15. (canceled)

16. The transmitting method according to claim 1, further comprising:
determining a monitoring start symbol corresponding to the PDCCH according to the first symbol length;
wherein determining the monitoring start symbol corresponding to the PDCCH according to the first symbol length comprises:
determining that the monitoring start symbol is the same as a start symbol occupied by a symbol 0 within the CORESET; and
determining the first symbol length as a persistence symbol length for monitoring the PDCCH.

17. (canceled)

18. The transmitting method according to claim 1, further comprising:
determining, in response to scheduling a physical downlink shared channel (PDSCH) in a same slot, a transmission symbol for the PDSCH or the PDCCH according to a mapping type of the PDSCH;
wherein determining the transmission symbol for the PDSCH or the PDCCH according to the mapping type of the PDSCH comprises:
determining, in response to the mapping type of the PDSCH being mapping type A, that the PDCCH is transmitted on N symbols occupied by the CORESET; and
determining, in response to the mapping type of the PDSCH being mapping type B, that a transmission start symbol for the PDSCH is not earlier than a monitoring start symbol for the PDCCH.

19-20. (canceled)

21. A transmitting method for PDCCH, executed by a network device, comprising:
determining, according to a first symbol length occupied by a CORESET currently, the CORESET configured for a terminal, wherein the CORESET comprises a REG, and the first symbol length is greater than 3;
determining a REG number of the REG, and mapping the REG into one or more REG bundles according to the REG number and granularity of the REG bundles;
obtaining a CCE by performing resource mapping on the one or more REG bundles; and
transmitting the PDCCH to the terminal.

22. The transmitting method according to claim 21, wherein before determining the REG number of the REG, and mapping the REG into one or more REG bundles according to the REG number and the granularity of the REG bundles, further comprises:
determining a numbering rule and a REG bundle mapping rule corresponding to the CORESET, numbering the REG according to the numbering rule, determining the REG number of the REG, and obtaining one or more REG bundles by mapping the REG according to the REG bundle mapping rule;
wherein mapping the REG into one or more REG bundles according to the REG number and the granularity of the REG bundles comprises at least one of:
obtaining the one or more REG bundles by mapping a REG packet according to a sequence of the REG number based on original first granularity of the REG bundles; or
obtaining the one or more REG bundles by mapping a REG packet according to a sequence of the REG number based on updated second granularity of the REG bundles.

23-24. (canceled)

25. The transmitting method according to claim 21, wherein the CORESET comprises K time units, the K time units being REG numbered among themselves in a time sequence, wherein K is a positive integer greater than or equal to 2, and the time unit comprises one or more symbols;
wherein determining the REG number of the REG comprises at least one of:
numbering the REGs within each time unit in a manner that time domain resources are numbered followed by frequency domain resources; or
numbering REGs within odd-numbered time units among the K time units in a manner that time domain resources are numbered followed by frequency domain resources and the frequency domain resources are numbered in reverse order; or
numbering REGs within even-numbered time units among the K time units in a manner that time domain resources are numbered followed by frequency domain resources and the frequency domain resources are numbered in sequential order.

26. (canceled)

27. The transmitting method according to claim 25, wherein obtaining the CCE by performing the resource mapping on the REG bundles comprises:
mapping, whenever the numbering of REGs within one time unit is completed, the REGs within the one time unit into one or more REG bundles, and obtaining the CCE by performing the resource mapping on the one or more REG bundles; and
after the one or more REG bundles within the one time unit are mapped to the CCE, numbering REGs in the next time unit, and performing a subsequent mapping process.

28. The transmitting method according to claim 21, wherein determining the REG number of the REG comprises at least one of:
numbering REGs on all symbols occupied by the CORESET in a manner that time domain resources are numbered followed by frequency domain resources; or
numbering REGs on all symbols occupied by the CORESET in a manner that frequency domain resources are numbered followed by time domain resources.

29. (canceled)

30. The transmitting method according to claim 25, wherein a process for determining a time domain length of the time unit comprises:
determining an original symbol length set of the CORESET, wherein the original symbol length set comprises at least one second symbol length;
determining, in response to the first symbol length being divisible by one and only one second symbol length, the one and only one second symbol length as the time domain length of the time unit;
determining, in response to the first symbol length being divisible by all the second symbol lengths, one of the second symbol lengths as the time domain length of the time unit; and
performing, in response to the first symbol length being indivisible by any one of the second symbol lengths, at least one of:
determining 1 as the time domain length of the time unit; or,
adjusting the first symbol length until the first symbol length is divisible by one of the second symbol lengths.

31. The transmitting method according to claim 21, wherein determining the CORESET configured for the terminal comprises:
configuring a same number of frequency domain resources or a different number of frequency domain resources for a time unit comprised in the CORESET;
wherein configuring the same number of frequency domain resources or the different number of frequency domain resources for the time unit comprised in the CORESET comprises at least one of:
configuring a first number of frequency domain resources for first L time units in K time units, and configuring a second number of frequency domain resources for remaining K-L time units; or
configuring a different number of frequency domain resources for each time unit in the K time units; or
configuring a same number of frequency domain resources for each time unit in the K time units.

32-34. (canceled)

35. The transmitting method according to claim 22, wherein a process for determining the second granularity of the REG bundles comprises at least one of:
determining that the second granularity is the same as the first symbol length; or
determining that the second granularity is an integer multiple of the first symbol length.

36-37. (canceled)

38. The transmitting method according to claim 21, further comprising:
determining a monitoring start symbol corresponding to the PDCCH according to the first symbol length;
wherein determining the monitoring start symbol corresponding to the PDCCH according to the first symbol length comprises:
determining that the monitoring start symbol is the same as a start symbol occupied by a symbol 0 within the CORESET; and
determining the first symbol length as a persistence symbol length for monitoring the PDCCH.

39. (canceled)

40. The transmitting method according to claim 21, further comprising:
determining, in response to scheduling a physical downlink shared channel (PDSCH) in a same slot, a transmission symbol for the PDSCH or the PDCCH according to a mapping type of the PDSCH;
wherein determining the transmission symbol for the PDSCH or PDCCH according to the mapping type of the PDSCH comprises:
determining, in response to the mapping type of the PDSCH being mapping type A, that the PDCCH is transmitted on N symbols occupied by the CORESET; and
determining, in response to the mapping type of the PDSCH being mapping type B, that a transmission start symbol for the PDSCH is not earlier than a monitoring start symbol for the PDCCH.

41-50. (canceled)
